(19) United States
(12) Patent Application Publication
(10) Pub. No.: US 2006/0250277 A1
(43) Pub. Date: Nov. 9, 2006

(54) Public service system

(75) Inventor: Sel Brian Colak, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics

(21) Appl. No.: 10/555,405

(22) PCT Filed: May 5, 2004
(86) PCT No.: PCT/IB04/50589

§ 371 Date: Nov. 2, 2005

(30) Foreign Application Priority Data
May 7, 2003 (EP) 03101260.2

(51) Int. Cl. G08G 1/14

(52) U.S. Cl. 340/932.2; 340/905

(57) ABSTRACT

A public service system comprises: automatic request recognition means, capable of automatically recognizing a user request, automatic user identification means, capable of automatically identifying the requesting user, automatic authorization means, capable of automatically checking a user's authorisation; a wireless communication network (110) having a plurality of communication nodes (111, 112, 113, 114) capable of direct or indirect communication with each other; a central controller (120; 220) associated with at least one of said communication nodes; and request receiving means associated with at least one of said communication nodes.

The present invention relates in general to a public service system, comprising service points where a user can obtain a certain public service in return for paying a service fee. By way of example, the service involves the provision of parking space for a vehicle. In another example, the service involves the provision of power. The present invention will hereinafter specifically be explained for these examples, but it is noted that the present invention is not limited to these exemplary applications.

In the art, it is known that city authorities tend to make parking of vehicles in parking spaces dependent on payment of a parking fee. As a consequence, a system needs to be developed regarding, in general, requesting parking space, obtaining authorisation to park at a certain parking place, and handling payment of the parking fee.

Several types of parking meters have been developed for this purpose. A conventional type of parking meter is coin-operated. The meter is located adjacent a parking place. On input of one or more coins (or tokens), a predefined amount of parking time becomes available. A timing mechanism, typically a mechanical mechanism, indicates whether the parking time is still running. One disadvantage of such system is that individual parking meters have to be provided for each individual parking place, which makes the system rather expensive. A second disadvantage is that parking attendants are necessary for checking whether the parked cars are paid for, and writing a fine if the parking time for a certain car has passed.

Instead of individual parking meters, systems exist where one common central parking meter is associated with a plurality of parking places. On input of one or more coins, the meter produces a piece of paper having a time printed thereon, indicating the duration of the parking time “bought”; the user is to place this piece of paper behind his windscreen. Although this may reduce costs, it introduces a burden to the driver, who has to park his car, go to the central parking meter and obtain a ticket, and to go back to his car to place the ticket in the car. The need for parking attendants remains.

In a more advanced system, parking places are numbered. In a central parking meter, the user introduces his coins, and also enters the number of his parking place. The system now knows that this specific parking place is occupied, and is paid for until a certain end time, which end time is communicated to the user, typically by means of a display.

Although the number of parking meters can thus be reduced, it is still necessary to have multiple meters, if only because the walking distance between the parking place and the associated parking meter should be limited.

All such systems as mentioned above have the common disadvantage that the user (driver) needs to estimate the amount of time he wants to leave his vehicle parked. If he needs more time, he has to go back to his car anyway for adding payment. If he leaves early, he has paid for more time than needed. This type of disadvantage is reduced in systems where a user is registered on entry and pays on leaving. On entry, the user receives a ticket, which he has to enter into a (central) payment machine on leaving the parking place. The system calculates the amount of time between entry and exit, and charges the corresponding amount due. After having received the correct amount of payment, the machine produces a ticket or token with which the user can operate an exit gate, or the exit gate is opened automatically by the machine. However, such systems involve increased costs because of the more complicated apparatus needed, such as ticket-operated or token-operated or machine-controlled gates.

It may be that such system is only available to a restricted group of people, in which case the user needs to identify himself on entry; the system checks whether the user is authorized, and refuses access to a non-authorized user.

In another development, a parking meter will accept electronic payment means, such as for instance an electronic payment card. In such case, the parking meter needs to be equipped with telecommunication means in order to communicate details of the payment transaction.

All these systems as known today require action from the user, i.e. the car driver. Depending on the system, the user needs to go to a certain location for payment, and/or needs to enter information regarding the parking space, and/or needs to enter information regarding his ID, and/or needs to enter coins or the like, and/or needs to return to his car for placing a ticket, etc.

Further, these systems are open to fraud to a larger or lesser degree: for instance, in the case of a system where a user needs to buy a ticket for a predetermined length of time, it is possible that he hands over his ticket to a next user if he leaves before said predetermined length of time has passed. This is similar to the conventional parking meters, in a situation where one has to insert coins: if one leaves early, a next user may park his car at the parking meter without payment, the parking meter still showing parking time left: the first driver should have paid less, the second driver should have paid more.

Further, the above-mentioned systems have the general disadvantage that personnel must be present, for instance to handle cases where problems with payment arise, to check for unauthorized parking, for maintenance and repair of the apparatus, etc.

A general objective of the present invention is to eliminate or at least reduce all or at least some of the above-mentioned disadvantages.

More particularly, the present invention aims to provide a system capable of automatically performing all actions regarding authorisation and payment, preferably also fining for unauthorised and/or unpaid parking.

As another example of public service facilities, public power provision points have been developed, where a user can obtain electric energy. Typically, these public power provision points were intended for charging car batteries, specifically for electrically powered vehicles, or for heating a car or its battery during a cold period. Apart from needing an electric power infrastructure, including power lines to the power provision points, the system needs also to have metering devices, for letting the user pay for the service: the user is billed for the amount of time that he receives electrical power, or for the amount of energy received. Further, it may be desirable to have some authorisation protocol available, for denying service to unauthorised persons.

Power provision points can also be found on campings: a camper can link his electrical equipment to the power provision point associated with his camp site. In such case, billing and authorisation is usually less complicated: the user obtains a key giving access to the outlet, and pays a fixed amount per day when he checks out. In contrast, public power provision points are available to anyone, and there is no check-out.

In many ways, the metering devices which have been developed for public power provision points resemble parking metering devices in that they are typically coin-operated (or operated on the basis of electronic payment), and in that they only provide electrical power during the amount of time paid for, or until having provided the amount of energy paid for. These metering systems also have disadvantages similar to the disadvantages discussed above with reference to parking meters: for each power outlet, an associated metering device is needed, and the user has to estimate in advance how much time or energy he wishes to “buy”. Unlike parking meters, systems where the user can pay after having received the electrical energy, either expressed in units time or in units energy, have not become available.

Further, the user has to perform actions with an aim to obtain authorisation and to effect payment. This requires, in general, that the public power provision system is equipped with communication means for receiving data input by the user, and hardware for receiving and handling payment.

The present invention aims to provide an improved public service system. Particularly, the present invention aims to provide a public service system capable of automatically detecting and recognizing a user request for service, automatically providing the service, and automatically charging for the service.

According to an important aspect of the present invention, a public service system comprises:

automatic request recognition means, capable of automatically recognizing a user request,

automatic user identification means, capable of automatically obtaining information regarding the identity of the requesting user;

automatic authorization means, capable of automatically authorizing or rejecting the user request;

a wireless communication network having a plurality of communication nodes capable of direct or indirect communication with each other;

a central controller associated with at least one of said communication nodes; and request receiving means associated with at least one of said communication nodes.

Depending on the precise application of the invention, the public service system may further comprise automatic service provision means, capable of automatically providing the required service if the authorization means decide that the user is authorized, or automatic cost settlement means, capable of automatically taking administrative action for settling the costs of the service provided.

These and other aspects, features and advantages of the present invention will be further explained by the following description with reference to the drawings, in which same reference numerals indicate same or similar parts, and in which:

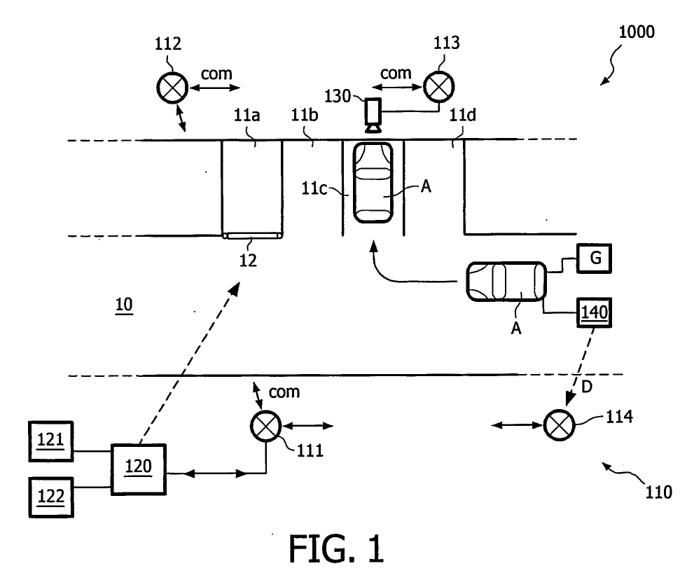

FIG. 1 schematically illustrates a parking system in accordance with the present invention;

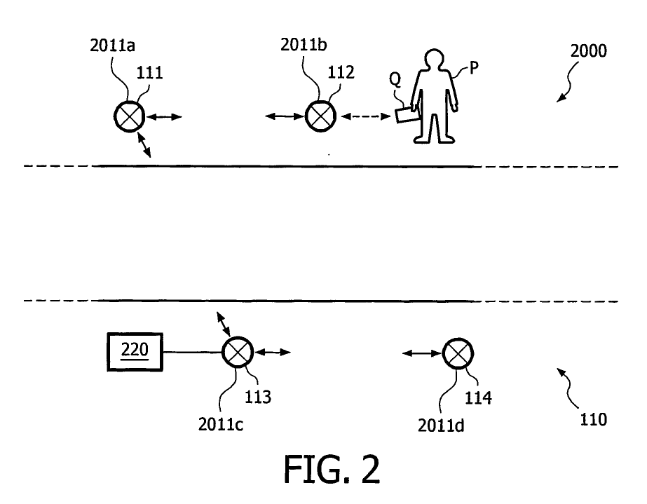

FIG. 2 schematically illustrates a power provision system in accordance with the present invention;

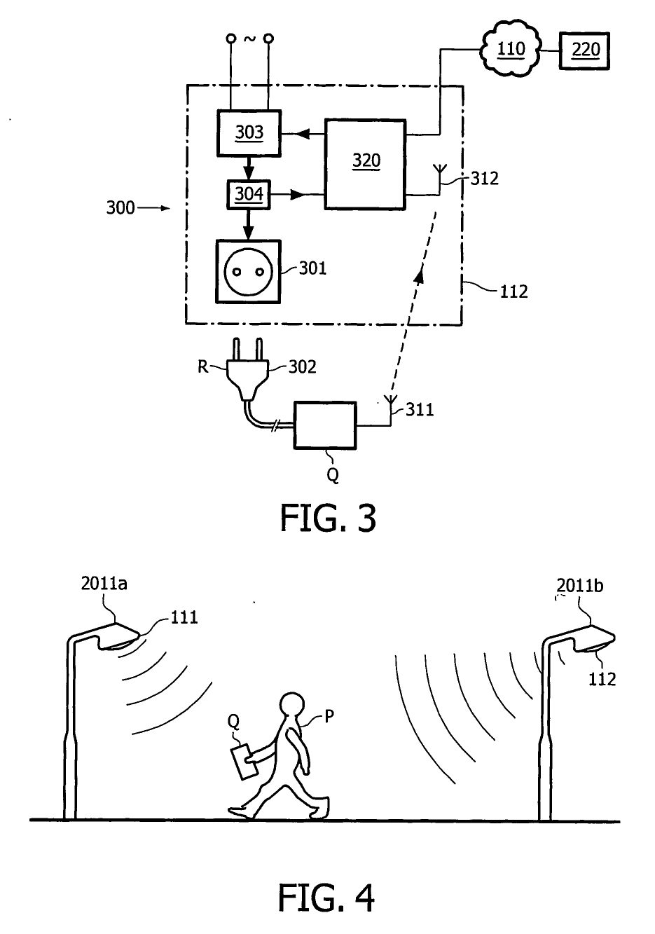

FIG. 3 is a block diagram schematically illustrating a communication node of the power provision system of FIG. 2;

FIG. 4 is a schematic view illustrating a user being allowed to move while receiving power from the power provision system in accordance with the present invention.

FIG. 1 schematically shows a first embodiment of a public service system, in this case a parking system 1000. The parking system 1000 is associated with a street 10, provided with a plurality of parking places 11, of which four are individually designated 11a, 11b, 11c, 11d. FIG. 1 also shows a vehicle A driving in the street 10, entering a free parking place 11c.

The parking system 1000 comprises a central controller 120.

The parking system 1000 further comprises a wireless communication network 110 having a plurality of communication nodes 111, 112, 113, 114. Each communication node comprises at least one transceiver (not shown separately) that is capable of bidirectional data communication, preferably optically, with at least one of the other nodes, as indicated by arrows COM. At least one of said communication nodes (in the figure: node 111) is capable of bidirectional data communication, preferably optically, with said central controller 120. Thus, the central controller 120 is capable of receiving data collected by all of said communication nodes 111, 112, 113, 114 together.

The parking system 1000 further comprises automatic detecting means, capable of detecting the fact that a vehicle enters a parking place.

In one embodiment, at least one of the communication nodes (in the figure: node 113) is associated with a video camera 130. Preferably, each of the communication nodes 111, 112, 113, 114 is associated with a video camera 130. The video camera 130 is arranged such that it views the parking places 11 in the street 10. The video camera may be mounted stationary, in which case it has a fixed field of view, but it is also possible that the video camera moves to sweep its field of view over the different parking places 11. The camera images are constantly or regularly passed on to the central controller 120 through the network 110. In such embodiment, the central controller 120 is provided with image processing means, capable of pattern recognition to recognize an object (vehicle) and to recognize the location of the object (parking place 11c). Since such image processing software is known per se, it is not necessary here to explain this aspect in more detail.

The central controller 120 is further provided with a clock device 121, capable of generating a signal indicating actual time-of-day and date. The central controller 120 is further provided with a memory 122. When the controller 120 establishes the fact that a user has requested parking facility, it will store the corresponding date and time into the memory 122.

Thus, the central controller 120 is capable of detecting the fact that a vehicle enters a parking place; this fact is interpreted as a “request” for obtaining a service (parking facility). After the controller 120 has established the fact that a user has requested parking facility, it will determine whether the request comes from an authorised user. To this end, the image processing software of the controller 120 is designed to read a registration number of the vehicle A. The user should have registered this number at the organisation managing the parking places, and the controller 120 checks whether the registration number as read by its image processing software is a known number. If the registration number is not known to the controller 120, it takes appropriate action. For instance, it may send a message to competent authorities (i.e. the police, a parking attendant), who may come and fine the vehicle, or even tow the vehicle away.

In a more elaborate embodiment, each parking place is provided with a controllable gate 12, as shown in FIG. 1 for parking place 11a. In such embodiment, a vehicle would approach the controllable gate 12 of the parking place 11a, and this fact would be recognised by the video camera 130: again, this fact is interpreted as a “request” for obtaining a service (parking facility). The controller 120 checks whether the request comes from an authorised user, by reading the vehicle registration number and comparing this number with a data base of authorised registration numbers, which may be stored in the memory 122. If the controller 120 finds a match, it will activate an actuator of the controllable gate 12 to open the gate; the vehicle A can now enter the parking place 11a. Also, the controller 120 stores the corresponding date and time of entry into the memory 122, as mentioned above. If the controller 120 finds no match, it will simply deny the parking facility, i.e. the gate 12 remains closed.

When the vehicle A leaves the parking place, this fact is also recognised by the image processing software of the controller 120, who stores the corresponding date and time of departure into the memory 122. In the case of the embodiment with controllable parking gate 12, the controller 120 will activate the actuator of the controllable gate 12 to close the gate. Further, the controller 120 calculates the duration of the stay in the parking place from the time of entry to the time of departure, which information is transferred to a financial department of the managing organisation, who will take appropriate steps to charge the user. In a specific embodiment, the controller 120 may be adapted to charge the costs involved directly to the user's bank account, using techniques similar to or equal to the techniques employed in common bank card reading machines.

All in all, the system is very user friendly, because the (authorised) user can freely park his car in any of the parking places belonging to the system: payment is done automatically, without the user needing to perform specific actions.

An important element of the parking system 1000 are the means capable of recognising that a user is requesting the parking facility, and capable of recognising who the user is, in order to be able to give or deny permission and in order to be able to charge the user. In the embodiment as described above, this element of the parking system 1000 comprises one or more video cameras plus image processing software. An important advantage of such embodiment is that no specific adaptations to the vehicles are required. Further, the video cameras may be usefully employed for other tasks, such as surveillance tasks.

However, the video cameras plus image processing software are not essential to the invention. Other embodiments may comprise other means for recognising vehicles and for recognising that a user requests parking facility. For instance, authorised vehicles may be provided with a machine-readable identification means, such as for instance a bar code, an RF tag, etc, and the system may comprise suitable reading machines associated with the parking places.

In an especially preferred embodiment, an authorised vehicle A is equipped with a transmitter 140 capable of data communication, preferably optically, preferably bidirectionally, with at least one of the nodes, as indicated by arrow D.

The vehicle's transmitter 140 is designed to continuously or regularly transmit a signal containing information regarding the identity of the vehicle A and/or its user, which signal is received by at least one of the communication nodes 111, 112, 113, 114 of the system 1000. Thus, the central controller 120 of the system 1000 knows that car A is driving in street 10.

The system 1000 is further designed to derive the vehicle's position from the signal received from the vehicle.

In one embodiment, the signal transmitted by the vehicle A is received by at least three of the communication nodes 111, 112, 113, 114, so that the central controller 120 is able to calculate the location of the vehicle A on the basis of the arrival times of the vehicle signal at the nodes. To facilitate this calculation, the vehicle's transmitter 140 may be designed to incorporate timing information into the transmitted signal. To this end, each of the communication nodes 111, 112, 113, 114 is equipped with an accurate clock device, capable of accurately determining time-of-day, while also the authorised vehicle A is equipped with an accurate clock device, capable of accurately determining time-of-day. The vehicle's transmitter 140 is designed to incorporate accurate time-of-day information into its signal. A communication node is designed, on receiving the vehicle's signal, to accurately mark the time of reception. From the timing difference, on the basis of the propagation speed of the signal, assuming straight line propagation, the distance between vehicle and node can be calculated. The communication node may be designed to perform this calculation itself and to communicate the result to the central controller 120, but it is also possible that the nodes communicate to the central controller 120 the data regarding time of reception of a signal and time of transmission of this signal, in which case the controller 120 is designed to perform the position calculation.

For accurate position calculation, it is important that the authorised vehicle A comprises an accurate clock device, and that the communication nodes each comprise accurate clock devices. Further, it is important that such clock devices are synchronised. In a preferred embodiment, each of said clock devices comprises a GPS receiver, receiving the GPS signal from the well-known GPS satellite system, which signal contains accurate time information, as is commonly known to persons skilled in the art.

In an alternative embodiment, the vehicle's transmitter 140 is designed to incorporate position information into the continuously or regularly transmitted signal, this position information relating to its actual position. The vehicle may in principle obtain its position information from any source. In a specifically preferred embodiment, the vehicle A is equipped with a GPS receiver G, receiving the GPS signals from at least three satellites of the well-known GPS satellite system, the GPS receiver being capable of calculating its position coordinates from the received GPS signals, as is commonly known to persons skilled in the art. At least one of the communication nodes 111, 112, 113, 114 receives the signal transmitted by the vehicle, and passes on the vehicle position information to the central controller 120 over the network 110.

The central controller 120 also has information regarding the fixed locations of the parking places 11, the fixed locations of any gates 12, etc. The central controller 120 is designed to compare the vehicle position, either calculated or communicated, with these fixed locations. Thus, based on the vehicle position, either calculated or communicated, the central controller 120 can determine that the vehicle A is entering the parking place 11c, or is located before the closed gate 12 of parking place 11a, and the central controller 120 can proceed as described above.

The exact location of said communication nodes 111, 112, 113, 114 is not critical. However, in order for the central controller 120 to be able to determine the position of the vehicle A with sufficient accuracy to determine that the vehicle A has entered a specific parking place, the communication nodes 111, 112, 113, 114 are preferably arranged at mutual distances in the order of 10-50 meters. Smaller distances will increase the accuracy but will also increase the costs of the system.

In a preferred embodiment, each communication node 111, 112, 113, 114 is associated with a corresponding street lighting armature.

FIG. 2 schematically shows a second embodiment of a public service system, in this case a power provision system 2000. The power provision system 2000 is associated with a street 10, provided with a plurality of street poles 2011, of which four are individually designated 2011a, 2011b, 2011c, 2011d. FIG. 2 also shows a person P walking the street 10.

The power provision system 2000 further comprises a wireless communication network 110, which may be identical to the communication network 110 described with reference to FIG. 1. The communication network 110 comprises communication nodes 111, 112, 113, 114, which, in this embodiment, are each associated with a corresponding street pole 2011. The power provision system 2000 comprises a central controller 220, associated with anode 113.

The user (person P) carries a portable battery-operated apparatus Q, for instance a mobile telephone, an MP3 player, etc. The battery is low, and needs to be recharged. Or, the apparatus may be programmed to constantly charge the battery, if possible, in order to keep the energy level in the battery as high as possible. In both cases, the apparatus requires power.

The system 2000 comprises energy transfer means 300, and the user apparatus Q comprises corresponding energy receiving means R In a possible embodiment, the energy transfer may be via a wired link. In fact the energy transfer means may comprise a power outlet 301, and the energy receiving means R may comprise a suitable connector 302. The power outlet may provide power at 220 V AC, 12 V DC, or similar commonly used standards.

In another possible embodiment the energy transfer may be via a wireless link. For instance, the energy transfer may be via electromagnetic waves: the energy transfer means may comprise a light source and the energy receiving means may comprise an photodetector. Or, the energy transfer means may comprise a microwave source (an antenna or antenna array) and the energy receiving means may comprise a rectenna receiver. (As is known to persons skilled in the art a rectenna is a specially structured antenna (array) combined with a semiconductor rectifying system.)

The user apparatus Q is designed for communicating with the nodes of the system 2000, typically over an RF link; in FIGS. 2 and 3, the user apparatus Q is seen communicating with node 112. To this communication, the user apparatus Q comprises a transmitter 311, and the nodes comprise receivers 312. The user apparatus Q is designed to transmit a request signal, which contains a request for service (i.e. power) as well as a user ID. One (or more) of the nodes (in this case: node 112) receive the user request signal, and pass the message on to the central controller 220, either directly or via the network 110. The nodes may pass on the entire signal, so that the central controller 220 derives the user ID information and the request information, or the individual nodes may derive the user ID information and the request information and communicate merely this derived information to the central controller 220.

In an embodiment where physical proximity or even physical contact is required, such as in the case where a connector is to be plugged into a socket, this event itself may be considered to constitute a user request, and the user ID information may be hidden in the connector, which may be read by a suitable connector reader in the socket.

On receiving the user request, the central controller 220 will check the user ID and, similarly as discussed above for the parking system, will determine whether or not the user is an authorised user. If not, the central controller 220 will deny the service: no power is transmitted by the power transmitter, or the outlet will carry no power.

If the central controller 220 finds that the user ID is known, i.e. the user is authorised, it will release the power requested. In the embodiment of FIG. 3, comprising a socket 301 which requires a connector 302 to be plugged in, the socket 301 is associated with a controllable switch 303, controlled by a switch controller 320, which may receive commands from the central controller 220. The controllable switch 303 has an input connected to power lines, suitably the power lines which power the lighting of the corresponding lighting pole. The output of the controllable switch 303 is coupled to the socket 301. Depending on the condition of the controllable switch 303, the socket 301 does or does not receive power.

With the socket, a measuring device 304 may be associated, capable of measuring the amount of time that the socket is switched to the power lines, or capable of measuring the amount of energy taken from the socket.

If the user apparatus Q indicates that the service is no longer needed, for instance by the user withdrawing the connector 302 from the socket 301, the controllable switch 303 is switched OFF.

It is noted that the energy transfer means 300 do not need to be associated with street lighting poles. It is considered very advantageous if a user, while seated in a waiting room (for instance waiting for public transport such as train, bus, etc), or while seated in public transport such as train, bus, etc, is able to obtain power for his appliances, for instance lap top computer. Again, the energy transfer may take place via a socket/connector combination, but, more conveniently to the user, power transfer takes place wirelessly. The energy transfer means may comprise a power antenna mounted in a table top, and the energy receiving means may comprise a power-receiving antenna mounted in the bottom of the appliance (lap top computer). Likewise, a transmitter 311 may be mounted in the bottom of the appliance (lap top computer), and a receiver 312 may be mounted in the table top.

In the case of wireless energy transfer, it is possible that the user is not bound to a fixed location (seat in a train), but is, perhaps, allowed to walk the street. This is schematically illustrated in FIG. 4, showing the person P walking from lighting pole 2011b with node 112 to lighting pole 2011a with node 111. For such a situation, the system 2000 is preferably adapted to determine the position where the user is located, which information is communicated to the central controller 220 who, in response, determines which of the energy transfer devices is in the best position to service the user, and controls the “best positioned” energy transfer device to service the user. In the situation schematically illustrated in FIG. 4, the apparatus Q is much closer to node 111, and energy transfer from the energy transfer means 300 associated with node 111 will be more efficient than energy transfer from the energy transfer means 300 associated with node 112; thus, in this situation, node 111 will take over energy transfer from node 112.

This facility allows the user to move around. The user may move away from one service point to a location closer to another service point: automatically, without the user needing to perform any action, and typically without the user noticing, service is taken over by the other service point.

It is noted that the energy transfer efficiency can be improved if the energy transfer means 300 are capable of generating a beam of energy aimed at the location of the receiver (i.e. user). In case of energy transfer via an optical link, the energy transfer means may have a controllable adjustable lens system associated with the light source, a controller adjusting the lens system such that the beam is directed in the correct direction, as should be clear to a person skilled in the art. In case of microwave energy transfer, the energy transfer means may comprise a controllable adjustable antenna array, a controller adjusting the antenna array such that the microwave energy is concentrated in the correct direction, as should be clear to a person skilled in the art.

When the user apparatus Q indicates that the service is no longer needed, for instance by the user withdrawing the connector 302 from the socket 301, or by the user switching OFF the apparatus Q, the central controller 220 calculates how much the user needs to pay, and the payment operation is performed automatically, similarly as described above for the parking system.

It should be clear to a person skilled in the art that the present invention is not limited to the exemplary embodiments discussed above, but that several variations and modifications are possible within the protective scope of the invention as defined in the appending claims.

For instance, instead of a central controller, the nodes may each comprise an autonomous controller.

Further, although the present invention provides for a system with automatic payment facility, this payment facility is not an essential issue. After all, the service provided may be “free” for authorised persons.

Further, in stead of a large-scale embodiment having a central processor located at some distance from the location where the service is provided to users, the present invention is also applicable in a small-scale implementation, where the central processor is located close to the location where the service is provided to users, so that a communication network can be avoided. Or, as an alternative to a communication network, a central processor may communicate to the request receiving means through another medium, for instance a telephone link

In the above, the present invention has been explained with reference to block diagrams, which illustrate functional blocks of the device according to the present invention. It is to be understood that one or more of these functional blocks may be implemented in hardware, where the function of such functional block is performed by individual hardware components, but it is also possible that one or more of these functional blocks are implemented in software, so that the function of such functional block is performed by one or more program lines of a computer program or a programable device such as a microprocessor, microcontroller, digital signal processor, etc.

1. Public service system comprising:
automatic request recognition means, capable of automatically recognizing a user request,
automatic user identification means, capable of automatically identifying the requesting user;
automatic authorization means, capable of automatically checking a user's authorisation;
a wireless communication network (110) having a plurality of communication nodes (111, 112, 113, 114) capable of direct or indirect communication with each other;
a central controller (120; 220) associated with at least one of said communication nodes;
and request receiving means associated with at least one of said communication nodes.

2. Public service system according to claim 1, the central controller (120; 220) allowing or rejecting the user's request on the basis of the authorization means.

3. Public service system according to claim 2, further comprising controllable switch means controlled by said controller for selectively providing or not-providing the requested service.

4. Public service system according to claim 2, the central controller (120; 220) being designed to generate an alarm signal if it finds that a non-authorised user is enjoying the service.

5. Public service system according to claim 2, the central controller (120; 220) being designed to automatically take care of financial administration when the service is terminated.

6. Public service system according to claim 1, further comprising controllable service provision means associated with at least one of said communication nodes.

7. Public service system according to claim 1, implemented as a parking system (1000), wherein the request receiving means comprise a camera (130) with associated image processing software, capable of recognising that a vehicle (A) is entering or leaving a parking place (11).

8. Public parking system according to claim 7, wherein the image processing software is capable of reading a registration number of the vehicle.

9. Public parking system according to claim 8, further comprising a memory (122) having a data base of authorised registration numbers stored therein.

10. Public service system according to claim 1, implemented as a parking system (1000), further comprising machine-readable identification means adapted to be fixed to a vehicle, and reading devices associated with the parking places, the reading devices being coupled for communication with at least one of the communication nodes.

11. Public service system according to claim 1, implemented as a parking system (1000), further comprising a transmitter (140) adapted to be fixed to a vehicle, and capable of data communication (D) with at least one of the communication nodes.

12. Public parking system according to claim 11, wherein said transmitter is arranged to continuously or regularly transmit a signal containing identification information.

13. Public parking system according to claim 12, the system being designed to automatically derive a vehicle's position from the signal transmitted by said transmitter.

14. Public parking system according to claim 13, wherein said transmitter is arranged to include time information into the transmitted signal, wherein the communication nodes comprise timing means, and wherein the system is designed to calculate the vehicle's position on the basis of propagation time from the transmitter to the respective communication nodes.

15. Public parking system according to claim 14, wherein said transmitter and said communication nodes each comprise GPS receiving means, adapted to derive time information from received GPS signals.

16. Public parking system according to claim 13, wherein said transmitter is arranged to include position information into the transmitted signal.

17. Public parking system according to claim 16, wherein said transmitter comprises GPS receiving means, adapted to derive position information from received GPS signals.

18. Public service system according to claim 1, implemented as a parking system (1000), further comprising a controllable gate (12) at the entrance of a parking place (11a), controlled by a controller allowing or rejecting the user's request on the basis of the authorization means.

19. Public service system according to claim 1, implemented as a power provision system (2000), further comprising:
energy transfer means (300) controlled by said controller;
energy receiving means (302) adapted to be coupled to a user apparatus.

20. Public power provision system according to claim 19, wherein the energy transfer means comprise a power outlet (301) and wherein the energy receiving means (302) comprise a connector.

21. Public power provision system according to claim 20, wherein the connector comprises user ID information, and wherein the power outlet (301) comprises ID reading means.

22. Public power provision system according to claim 19, wherein the energy transfer means and the energy receiving means are adapted for wireless energy transfer.

23. Public power provision system according to claim 22, wherein the energy transfer means comprise a light source and wherein the energy receiving means comprise a photodetector.

24. Public power provision system according to claim 22, wherein the energy transfer means comprise an electromagnetic wave emitting antenna or antenna array, and wherein the energy receiving means comprise an electromagnetic wave receiving antenna, preferably incorporating rectenna technologies with one or more rectifiers.

25. Public power provision system according to claim 22, wherein the energy transfer means are capable of generating a beam of energy and directing this beam to the energy receiving means.

26. Public power provision system according to claim 25, further comprising a transmitter (311) adapted to be associated with a user apparatus, capable of transmitting a signal containing user location information, wherein the communication nodes comprise receiving means capable of receiving the said signal and capable of deriving the user location information from the received signal;
and wherein the energy transfer means are capable of directing a beam of energy to the location as derived from said received signal.

27. Public power provision system according to claim 19, further comprising a transmitter (311) adapted to be associated with a user apparatus, capable of transmitting a signal containing user ID information, wherein the communication nodes comprise receiving means capable of receiving the said signal and capable of deriving the user ID information from the received signal.

28. Public power provision system according to claim 19, further comprising a measuring device (304) capable of measuring the amount of power provided or time duration of the power provided.

29. System according to claim 1, wherein at least some of the nodes are associated with street lighting armatures or lamp posts.

30. System according to claim 1, wherein at least some of the nodes are designed for communication with each other over optical links.
